(19) United States
(12) Patent Application Publication
(10) Pub. No.: US 2009/0202861 A1
(43) Pub. Date: Aug. 13, 2009

(54) Copper-based deposited alloy strip for contact material and process for producing the same

(76) Inventors: Kuniteru Mihara, Tokyo (JP); Masato Ohno, Tokyo (JP); Naofumi Tokuhara, Tokyo (JP); Tatsuhiko Eguchi, Tokyo (JP)

Correspondence Address: Kazunao Kubotera;Kubotera & Associate, 200 Daingerfield Road, Suite 202, Alexandria, VA, 22314, US

(21) Appl. No.: 12/310,909

(22) PCT Filed: Sep. 13, 2007
(86) PCT No.: PCT/JP2007/067840

§ 371 Date: Mar. 12, 2009

(30) Foreign Application Priority Data
Sep. 13, 2006 (JP) 2006-248468
Sep. 12, 2007 (JP) 2007-237213

(51) Int. Cl. B32B 15/01; C22C 9/00; C22C 9/06; C22F 1/08

(52) U.S. Cl. 428/670; 428/672; 428/673; 420/469; 420/485; 148/686; 148/685

(57) ABSTRACT

A copper-based deposited alloy strip for a contact material has a maximum value of a difference not larger than 100 MPa among three of tensile strengths, that are a tensile strength in a rolling direction thereof, a tensile strength in a direction crossing the rolling direction with an angle of 45 degrees, and a tensile strength in a direction crossing the rolling direction with an angle of 90 degrees. A process for producing the copper-based deposited alloy strip for a contact material includes the steps of: performing a solution heated treatment on a copper alloy strip; and performing an aging heat treatment on the copper alloy strip.

### TECHNICAL FIELD

The present invention relates to a copper-based deposited alloy strip for a contact material, and a process for producing the copper-based deposited alloy strip for a contact material.

### BACKGROUND ART

In recent years, a push button switch for operation (ten keys), a multifunction switch (four directional switch for example), or the like has been used for an electronic device such as a portable telephone (refer to Japanese Patent Application Publication No. 2001-229783). For a conventional spring member of the switch, there is used a rolled strip to be press punched, which is comprised of a material such as stainless steel, phosphor bronze, brass, pure copper, or the like. For enhancing reliability thereof, a material such as Au, Ag, Pd, or the like is plated on the spring member (refer to Japanese Patent Application Publication No. 2005-002400).

### DISCLOSURE OF THE INVENTION

In the conventional spring member, a feeling of stroke upon operating a switch (feeling of pushing the switch), softness upon clicking the switch, or the like tends to vary depending on a direction of switching, thereby lowering operability of the switch.

An object of the present invention is to provide a copper-based deposited alloy strip for a contact material capable of improving an operability of a multifunction switch to be used for an electronic device or the like, and to provide a process for producing the copper-based deposited alloy strip for a contact material.

The present inventors have examined in a variety of manners for solving the above mentioned problems. As a result, it is found that the variance in the feeling of stroke according to the direction of switching increases when a mechanical anisotropy of a rolled strip increases in a step of drawing the rolled strip to a spring member. Further, the variance increases as the mechanical anisotropy of the rolled strip increases. Based on the findings, the present invention is achieved.

According to the present invention, the following aspects are provided.

(1) A copper-based deposited alloy strip for a contact material having a maximum value of a difference not larger than 100 MPa among a tensile strength in a rolling direction thereof, a tensile strength in a direction crossing the rolling direction with an angle of 45 degrees, and a tensile strength in a direction crossing the rolling direction with an angle of 90 degrees;

(2) The copper-based deposited alloy strip for a contact material according to the aspect (1), further having an electrical conductivity of not less than 30% IACS;

(3) The copper-based deposited alloy strip for a contact material according to the aspect (1) or (2), further having a top surface layer plated with a noble metal or an alloy thereof selected from the group consisting of Ag, Au, Pd, Ru, and Rh;

(4) The copper-based deposited alloy strip for a contact material according to the aspect (3), further having an under-plating layer formed of at least one of Cu, Ni, Fe, and Co or an alloy thereof;

(5) The copper-based deposited alloy strip for a contact material according to the aspect (4), wherein the under-plating layer is comprised of at least two layers;

(6) The copper-based deposited alloy strip for a contact material according to one of the aspects (1) to (5), containing Ni as between 2 and 4 mass %, Si as between 0.4 and 1 mass %, and a remaining component comprised of an unavoidable impurity and Cu;

(7) The copper-based deposited alloy strip for a contact material according to the aspect (6), further containing at least one selected from the group consisting of Mg as between 0.05 and 0.2 mass %, Sn as between 0.1 and 0.5 mass %, Zn as between 0.1 and 1 mass %, and Cr as between 0.05 and 0.5 mass %;

(8) A process for producing said copper-based deposited alloy strip for a contact material according to one of the aspects (1) to (7), comprising the steps of: performing a solution heated treatment on a copper alloy strip; and performing an aging heat treatment on the copper alloy strip;

(9) The process for producing the copper-based deposited alloy strip for a contact material according to the aspect (8), further comprising the step of performing a cold rolling on the copper alloy strip at a rolling rate not higher than 30%, after performing the aging heat treatment; and

(10) The process for producing the copper-based deposited alloy strip for a contact material according to the aspect (8) or (9), further comprising the step of performing an annealing on the copper alloy strip for relaxing a distortion thereof, after performing the aging heat treatment or the cold rolling at the rolling rate not higher than 30%.

The above and other aspects and advantages according to the present invention will be clarified by the following description.

### BEST MODE FOR CARRYING OUT THE INVENTION

Preferred embodiments regarding a copper-based deposited alloy strip suitable for a contact material according to the present invention will be described in detail below.

Regarding the copper-based deposited alloy strip according to the present invention, a maximum value is not larger than 100 MPa for each of differences between three of tensile strengths, that are a tensile strength in a direction of a rolling, a tensile strength in a direction with having an angle of 45 degrees from the rolling direction, and a tensile strength in a direction with having an angle of 90 degrees from the rolling direction. The reason to specify in such a manner is that a mechanical anisotropy excessively increases at a period of working for drawing in a case where the maximum value for each of the differences therebetween becomes over than 100 MPa, and then that an operability of a switch regarding a multifunction switch becomes to be worsened. Thus, it is desirable for the maximum value for each of the differences therebetween to be not larger than 50 MPa, and in particular it is further preferable to be not larger than 30 MPa.

The above mentioned three directions are in a plane parallel to a rolling plane.

In a conventional switch (one directional switch), an electric current passing therethrough is weak at approximately several mA, and an area of a contacting part is small, so that a noble metal is plated thereon to improve reliability thereof.

On the contrary, a multifunction switch has a larger size (having a diameter thereof not less than 10 mm) comparing to the conventional switch, and has a larger area of a contacting part thereof. Hence, it is able to use the multifunction switch without plating a noble metal thereon, even in a case where an electrical conductivity of a material is lower comparing to that of the conventional switch. In the case of the copper-based deposited alloy strip according to the present invention, it is able to use the same without plating a noble metal thereon when the electrical conductivity thereof is not lower than 30% IACS, or preferably not lower than 35% IACS.

In a spring member for contacting in the multifunction switch, it is desirable to improve reliability in the electrical conductivity thereof by reducing a value of a contact electrical resistance through providing a plated layer on a top surface thereof using a noble metal such as Au, Ag, Pd, Ru, Rh, or the like, or an alloy thereof. In the case, it is desirable to perform under-plating using at least one or an alloy of a metal selected from Cu, Ni, Fe, or Co, for enhancing wear and abrasion resistance, a sliding property, a adherence property, or the like of the plated layer comprised of the noble metal or the alloy thereof. Further, the under-plating is not limited to one layer, and may be comprised of not less than two layers.

A thickness of the plated layer comprised of the noble metal or the alloy thereof is desirable to be between 0.001 μm and 10 μm. When plating Au or Pd, it is optimum to be between 0.001 μm and 3 μm. When plating Ag, it is optimum to be between 0.1 μm and 6 μm. When plating Ru or Rh, it is optimum to be between 0.005 μm and 2 μm. It is difficult to obtain an effect of the plating when the thickness is thinner, and a production cost becomes higher when the thickness is thicker.

A thickness of the under-plated layer is desirable to be between 0.01 μm and 2 μm. When using Ni and Cu, it is optimum to be between 0.1 μm and 0.3 μm. It is difficult to obtain an effect of the plating when the thickness is thinner. When the thickness is thicker, a cracking tends to occur during press work, bending work, or drawing work.

In the copper-based alloy, an oxide layer is formed on a surface thereof in an air atmosphere. Accordingly, it is desirable to coat the copper-based alloy with an oxidation inhibitor such as BTA (benzotriazole) or the like within a range between 1 nm and 10 nm.

In the copper-based deposited alloy strip for contact materials according to the present invention, it is able to apply a material such as beryllium copper (C17200, C17530, or the like), titanium copper (C19900), chromium copper, an iron additive copper alloy (C19400), or the like. In particular, it is recommended to use a Corson alloy containing Ni as between 2 and 4 mass %, Si as between 0.4 and 1 mass %, and a remaining component comprised of copper and an unavoidable impurity, because it is superior in strength thereof and has an excellent electrical conductivity. In the Corson alloy, Ni and Si enhance the strength thereof by precipitating therefrom as an intermetallic compound.

When the Corson alloy contains at least one selected from a group comprised of Mg as between 0.05 and 0.2 mass %, Sn as between 0.1 and 0.5 mass %, Zn as between 0.1 and 1 mass %, and Cr as between 0.05 and 0.5 mass %, it is possible to improve further the strength thereof. Cr is precipitated in copper, Zn and Sn become a solid solution in copper, or Mg is precipitated in copper or becomes a solid solution therein, thereby improving the strength thereof.

Further, Sn and Zn improve creep resistance. Still further, Mg improves creep resistance and hot workability as well. Still further, Zn improves soldering property, adherence property relative to the plated layer.

In the copper-based deposited alloy strip for contact materials according to the present invention, a casting process, a process of homogenizing an ingot, a hot rolling process, a cold rolling process, a solution heated treatment process, and a aging heat treatment process are performed thereto in this order for example. At last, a cold rolling process is performed thereto at a rolling rate not higher than 30%.

According to the present invention, the solution heated treatment is performed for between five and fifteen seconds in a temperature range of between 700° C. and 925° C., for example, and then by cooling immediately thereafter at a speed not slower than 10° C. per second.

Moreover, the aging heat treatment is performed for between one hour and three hours in a temperature range of between 420° C. and 480° C., for example, and then by cooling immediately thereafter at a speed not slower than 10° C. per second.

According to the present invention, the copper-based deposited alloy strip is desirably produced by performing the final cold rolling process at the rolling rate not higher than 30%, after the solution heated treatment process and the aging heat treatment process. Moreover, depending on a required property of a copper alloy strip, the final cold rolling process is preferably performed at the rolling rate not higher than 20%.

Furthermore, an annealing process may be performed for relaxing a distortion thereof after the final cold rolling process. The annealing process for relaxing the distortion is preferably performed for between a half hour and two hours at a temperature of between 450 ° C. and 550° C., or for between one second and thirty seconds at a temperature of between 600° C. and 850° C.

According to the present invention, it is desirable for a tensile strength to be greater than 600 MPa after the aging heat treatment. When the tensile strength is less than 600 MPa, it is necessary to increase the rolling rate of the cold rolling process, thereby increasing mechanical anisotropy thereof. A copper alloy of a precipitation type such as beryllium copper, titanium copper, Corson alloy, or the like has a strength greater than 600 MPa after the aging heat treatment. Hence, it is able to obtain a required strength by the cold rolling process at the rolling rate not higher than 30%. Moreover, it is able to make the maximum value of the differences between the tensile strengths in the three directions thereof less than 100 MPa. The rolling rate is desirable to be not higher than 20%, more preferably not higher than 10%, for reducing the mechanical anisotropy thereof.

According to the present invention, the copper-based deposited alloy strip has high electrical conductivity and strength after performing the aging heat treatment process. Accordingly, it is possible to obtain a required strength for a spring member by performing the rolling process at the rolling rate not higher than 30%, thereby reducing the mechanical anisotropy thereof. As a result, the copper-based deposited alloy strip can be preferably used as the spring member for a contact in the multifunction switch.

In pure copper, an alloy of a copper-based solid solution type, or the like, it is necessary to perform the rolling process at a rate higher than 30% for obtaining a necessary strength, thereby increasing mechanical anisotropy thereof and deteriorating operability of the multifunction switch.

According to the present invention, the final cold rolling has a function of repairing (straightening) a shape of a strip as well. That is to say, when the solution heated treatment process is performed by a continuous annealing at a high temperature of between 700° C. and 925° C., a shape of a contact material tends to be collapsed due to a thin strip thickness (not larger than approximately 0.1 mm). Moreover, in the aging heat treatment process, the strip is rolled in a coil shape in a batch. Accordingly, the strip tends to maintain the coil shape. The cold rolling repairs a defect in such a shape.

According to the present invention, when the cooling speed is set between 10° C. per second and 200° C. per second after the solution heated treatment process, it is possible to reduce the defect in the shape of the strip created during the solution heated treatment process. Moreover, when the cooling speed is set between 0.01° C. per second and 1° C. per second after the aging heat treatment process, it is possible to correct the coil shape of the strip created during the aging heat treatment process. Thus, it becomes able to reduce the rate of the cold rolling by controlling the cooling velocity after the processes.

Furthermore, it is able to straighten further the shape of the strip by inserting a skin pass process at a rolling rate not higher than 5% between the solution heated treatment and the aging heat treatment.

According to the present invention, the copper-based deposited alloy strip for contact materials has the maximum value not larger than 100 MPa of the differences between three of the tensile strengths, that are the tensile strength in the rolling direction, the tensile strength in the direction with having the angle of 45 degrees from the rolling direction, and the tensile strength in the direction with having the angle of 90 degrees from the rolling direction. Accordingly, when the copper-based deposited alloy strip is used as the contact spring member of the multifunction switch, it is possible to reduce a variance in the stroke feeling or the like depending on a switching direction, thereby improving operability thereof.

According to the present invention, the copper-based deposited alloy strip for contact materials has the electrical conductivity not lower than 30% IACS and the small contact electrical resistance. Thus, when the copper-based deposited alloy strip is used as the contact spring member of the multifunction switch (having a large size), it is possible to eliminate a plating process using a noble metal, thereby reducing cost.

Further, the copper-based deposited alloy strip for contact materials has the contact electrical resistance further reduced by performing the plating process on a top surface layer part thereof using a noble metal such as Au, Ag, Pd, Ru, Rh, or the like, thereby improving reliability of electrical conductivity thereof. When the under-plating process is performed using Ni or Cu, it becomes able to improve wear and abrasion resistance, sliding property, adherence property, or the like of the noble metal plated layer thereof.

When the copper alloy strip contains Ni as between 2 and 4 mass %, Si as between 0.4 and 1 mass %, and a remaining component comprised of Cu and an unavoidable impurity, it is possible to improve electrical conductivity, spring property, and durability thereof, thereby reducing a size and a thickness of a switch. When the copper alloy contains at least one selected from the group comprised of Mg, Sn, Zn and Cr for a proper amount, it becomes able to improve the strength thereof or the like.

According to the present invention, the copper-based deposited alloy strip for contact materials can be easily produced by performing the aging heat treatment process on the copper alloy strip processed with the solution heated treatment, and then by performing the rolling process at the rolling rate as not higher than 30%.

### EXAMPLES

Next, the present invention will be described in further detail below based on the following examples. The present invention is not limited to the examples.

### Example 1

A copper alloy having a component as shown in Table 1 (a remaining component is comprised of Cu) is dissolved in a high frequency melting furnace. Then, the copper alloy is casted into an ingot approximately having a thickness of 30 mm, a width of 100 mm, and a length of 150 mm with a DC (direct casting) method. The ingot thus obtained is maintained at a temperature of 1,000° C. for one hour approximately, and the hot rolling process is performed until the ingot has a thickness of 12 mm approximately. Afterward, the ingot is cooled immediately. Next, both surfaces of the hot rolled strip are cut by a thickness of approximately 1.5 mm, so that an oxide layer thereof is removed. Next, the cold rolling is performed to have a thickness between 0.15 mm and 0.1 mm. Next, the solution heated treatment is performed in a temperature range of between 825° C. and 925° C. for fifteen seconds approximately, and then performed the cooling with a cooling velocity as not slower than 10° C. per second immediately thereafter. Next, the aging heat treatment is performed at a temperature of between 420° C. and 480° C. for one hour to three hours, and then the cooling is performed at a cooling velocity of approximately between 1° C. per second and 10° C. per second immediately thereafter.

Next, the cold rolling is performed with a variety of rolling rates not higher than 30%, that are shown in Table 1, thereby obtaining the strips (Samples: Nos. 1 to 15) having the strip thickness between 0.06 mm and 0.1 mm, respectively. Moreover, the conditions of the solution heated treatment and the aging heat treatment are selected properly corresponding to the alloy composition.

Further, the tensile strength and the electrical conductivity of the samples are examined. Still further, the spring member for contacting is produced from the samples by working for drawing, and then a movable piece part (having a dome shape with a diameter of 30 mm approximately) of a multifunction switch (four dimensional switch) is assembled using the spring member. Operability of the switch (variances depending on the direction of switching) such as a feeling of stroke or the like is evaluated by applying a load to four parts on the movable piece to be the contact parts (that are arranged around a circumference with a distance of approximately 10 mm and a spacing as 90 degrees from a center of the movable piece).

Regarding the method, a load displacement measuring apparatus is used with the load of 1 N and the stroke of 1 mm approximately (the load displacement accurate measuring apparatus, MODEL-1605N, produced by Aikoh Co.). An average value of the loads is evaluated by sequentially pushing three times the four parts to be the contact parts respectively, and then there is performed an assessment based on the index marks as described below.

In the assessment, the sample having extremely excellent operability of switching (having the difference between the maximum value and the minimum value of the average value of the load not larger than 10%) is represented as “⊚”. The sample having good operability of switching (having the difference between the maximum value and the minimum value of the average value of the load as larger than 10% but not larger than 25%) is represented as “◯”. The sample having poor operability of switching (having the difference between the maximum value and the minimum value of the average value of the load larger than 25%, or in the case where the spring member does not recover to the initial shape thereof after applying the load thereto) to be as “X”. Moreover, there is not performed a plating with using a noble metal for the spring member.

Regarding the tensile strength, tensile test pieces (the test pieces pursuant to JIS Z No. 2201-5) are cut out, which individually has three directions as the tensile direction, that are the direction of a rolling for the strip, the direction with having the angle of 45 degrees from the rolling direction, and the direction with having the angle of 90 degrees from the rolling direction. The tensile test is performed as pursuant to JIS Z 2241 under the conditions of the tensile speed of 10 mm per minute and of the gage length of 50 mm approximately. Moreover, the tensile strength in each of the directions is measured for three pieces thereof respectively, an average value thereof is calculated, and then the maximum value of the difference between the tensile strengths (the average values) corresponding to three of the directions is evaluated.

Regarding the electrical conductivity thereof, a specific resistance thereof is measured by using a four-terminal method in a constant temperature bath in which the temperature is maintained as at 20° C. (±0.5° C.), and then the electrical conductivity is calculated thereby. A distance between terminals therein is set to be as 100 mm approximately.

### Example 2

The samples (Nos. 16 and 17) have the compositions shown in Table 1. Except that the annealing for relaxing the distortion is performed approximately at 650° C. for three seconds after the cold rolling with the rolling rate as 20% or 15%, the samples Nos. 16 and 17 are prepared similar to those in Example 1. The examination is performed similar to Example 1.

### Example 3

The samples (Nos. 18 and 19) are obtained similar to those in Example 1, except that beryllium copper or titanium copper is used, and the rolling rate of the cold rolling after the aging heat treatment is set 12% or 15%. The examination is performed similar to Example 1. Moreover, the under-plating is performed using Ni for the contacting part of the spring member with the thickness of 0.3 μm approximately, and then Au is further plated thereon with the thickness of 0.04 μm approximately, because the alloys have the insufficient electrical resistivity.

### Comparative example 1

The Comparative samples (Comparatives 1 to 5) have the composition shown in Table 1. The comparative samples are obtained similar to those in Example 1, except that the rolling rate of the cold rolling after the aging heat treatment is set to 35% or 40%, which is greater than 30% as shown in Table 1. The examination is performed similar to Example 1.

The results of the assessments regarding Examples 1 to 3 and Comparative example 1 are shown in Table 1.

TABLE 1

| | | | | | ROLLING | | |
|---|---|---|---|---|---|---|---|
| | | | | | RATE | | STRENGTH |
| | | | | | AFTER | ANNEALING | IN |
| | | | | | AGING | FOR | ROLLING |
| | SAMPLE | COMPONENT (mass %) | | | TREATMENT | RELAXING | DIRECTION |
| GROUP | No. | Ni | Si | OTHER | (%) | DISTORTION | (MPa) |
| EXAMPLE 1 | 1 | 2.0 | 0.40 | — | 3 | None | 698 |
| | 2 | 3.0 | 0.65 | — | 10 | None | 722 |
| | 3 | 3.0 | 0.65 | — | 20 | None | 780 |
| | 4 | 2.0 | 0.40 | — | 30 | None | 700 |
| | 5 | 3.0 | 0.65 | 0.1Mg | 15 | None | 745 |
| | 6 | 2.5 | 0.56 | 0.5Zn | 5 | None | 703 |
| | 7 | 2.5 | 0.56 | 0.5Zn | 15 | None | 728 |
| | 8 | 2.5 | 0.56 | 0.5Zn, | 10 | None | 703 |
| | | | | 0.15Sn, | | | |
| | | | | 0.1Mg | | | |
| | 9 | 2.5 | 0.56 | 0.5Zn, | 15 | None | 734 |
| | | | | 0.15Sn, | | | |
| | | | | 0.1Mg | | | |
| | 10 | 2.5 | 0.56 | 0.5Zn, | 20 | None | 755 |
| | | | | 0.15Sn, | | | |
| | | | | 0.1Mg | | | |
| | 11 | 2.5 | 0.56 | 0.5Zn, | 25 | None | 779 |
| | | | | 0.15Sn, | | | |
| | | | | 0.1Mg | | | |
| | 12 | 3.75 | 0.90 | 0.5Zn, | 10 | None | 811 |
| | | | | 0.15Sn, | | | |
| | | | | 0.1Mg | | | |
| | 13 | 3.75 | 0.90 | 0.5Zn, | 20 | None | 863 |
| | | | | 0.15Sn, | | | |
| | | | | 0.1Mg | | | |
| | 14 | 3.75 | 0.90 | 0.5Zn, | 8 | None | 820 |
| | | | | 0.15Sn, | | | |
| | | | | 0.1Mg, | | | |
| | | | | 0.1Cr | | | |
| | 15 | 3.75 | 0.90 | 0.5Zn, | 15 | None | 845 |
| | | | | 0.15Sn, | | | |
| | | | | 0.1Mg, | | | |
| | | | | 0.1Cr | | | |
| EXAMPLE 2 | 16 | 3.0 | 0.65 | — | 20 | Yes | 732 |
| | 17 | 3.0 | 0.65 | 0.1Mg | 15 | Yes | 729 |
| EXAMPLE 3 | 18 | — | — | 2.9Ti | 12 | None | 812 |
| | 19 | — | — | 1.8Be | 15 | None | 855 |
| COMPARATIVE | COM. 1 | 3.0 | 0.65 | 0.1Mg | 35 | None | 782 |
| EXAMPLE 1 | COM. 2 | 2.5 | 0.56 | 0.5Zn | 35 | None | 792 |
| | COM. 3 | 2.5 | 0.56 | 0.5Zn, | 35 | None | 796 |
| | | | | 0.15Sn, | | | |
| | | | | 0.1Mg | | | |
| | COM. 4 | 3.75 | 0.90 | 0.5Zn, | 35 | None | 863 |
| | | | | 0.15Sn, | | | |
| | | | | 0.1Mg | | | |
| | COM. 5 | 3.75 | 0.90 | 0.5Zn, | 40 | None | 869 |
| | | | | 0.15Sn, | | | |
| | | | | 0.1Mg, | | | |
| | | | | 0.1Cr | | | |

| | | MAXIMUM | | | |
|---|---|---|---|---|---|
| | | DIFFERENCE | | | |
| | | OF | ELECTRICAL | | |
| | SAMPLE | STRENGTH | CONDUCTIVITY | SWITCH | |
| GROUP | No. | (MPa) | (% IACS) | OPERABILITY | NOTE |
| EXAMPLE 1 | 1 | 16 | 44 | ◯ | |
| | 2 | 32 | 35 | ◯ | |
| | 3 | 62 | 34 | ◯ | |
| | 4 | 22 | 45 | ◯ | |
| | 5 | 45 | 34 | ◯ | |
| | 6 | 23 | 41 | ◯ | |
| | 7 | 42 | 40 | ◯ | |
| | 8 | 30 | 39 | ◯ | |
| | 9 | 48 | 38 | ◯ | |
| | 10 | 67 | 37 | ◯ | |
| | 11 | 81 | 37 | ◯ | |
| | 12 | 28 | 34 | ◯ | |
| | 13 | 66 | 33 | ◯ | |
| | 14 | 27 | 34 | ◯ | |
| | 15 | 37 | 33 | ◯ | |
| EXAMPLE 2 | 16 | 9 | 37 | ⊚ | |
| | 17 | 11 | 36 | ⊚ | |
| EXAMPLE 3 | 18 | 23 | 11 | ◯ | Au plated |
| | 19 | 34 | 24 | ◯ | on |
| | | | | | contacting |
| | | | | | part |
| COMPARATIVE | COM. 1 | 108 | 38 | X | |
| EXAMPLE 1 | COM. 2 | 110 | 42 | X | |
| | COM. 3 | 104 | 41 | X | |
| | COM. 4 | 116 | 37 | x | |
| | COM. 5 | 121 | 36 | X | |

As it is obvious from Table 1, all of the samples according to the present examples (Examples 1 to 3) individually have the maximum differences of the strength in each of the three directions as not larger than 100 MPa, respectively, and have the operability of switching as sufficiently good for each thereof. Moreover, the samples according to Example 2 (Nos. 16 and 17) in particular, that are performed the process of the annealing for relaxing the distortion thereon respectively, individually has the maximum difference of the strength as becoming to be extremely smaller, and then has the operability of switching as extremely excellent for each thereof. Further, the samples according to Examples 1 and 2 (Nos. 1 to 17) individually has the electrical conductivity as not smaller than 30% IACS, and then there becomes not happened any contact failure therebetween even without performing the plating with using the noble metal thereon for each thereof.

On the contrary, all of the samples according to the comparative example (Nos. 1 to 5) become to have the maximum differences of the strength in each of the three directions as over than 100 MPa. Hence, the mechanical anisotropy of the spring member becomes to be increased at the period of working for drawing the member, and then the operability of switching thereby becomes to be inferior thereto.

### Example 4

The samples (Nos. 21 to 35) are obtained, that the spring members are used as the base materials, by performing the plating to be as a underlying layer, an intermediate layer and a top surface layer from the near side to the copper alloy as shown in Table 2 at the contacting part for each thereof (there are cases where there is no underlying layer and no intermediate layer). And then the examination is performed for the samples as similar to that for Example 1.

The base materials are Nos. 8, 12 and 14 as shown in Table 2, that correspond to the samples Nos. 8, 12 and 14 as shown in Table 1, respectively, and are prepared similar to those described in Example 1. Therefore, all the conditions of the component, the rolling rate after the process of the aging heat treatment, the annealing for relaxing the distortion thereon, and the strength and the maximum difference of the strength in the direction of the rolling are similar to each thereof as described in Table 1 respectively, and the description to be duplicated is omitted in Table 2.

TABLE 2

| | | BASE | | | TOP | ELECTRICAL | OPERA- |
|---|---|---|---|---|---|---|---|
| | SAMPLE | MATERIAL | UNDERLYING | INTERMEDIATE | SURFACE | CONDUC- | BILITY OF |
| GROUP | No. | No. | LAYER | LAYER | LAYER | TIVITY | SWITCHING |
| EXAMPLE | 21 | 8 | NONE | NONE | Ag: 2 μm | 39 | ◯ |
| 4 | 22 | 8 | Cu: 0.2 μm | NONE | Ag: 2 μm | 39 | ◯ |
| | 23 | 8 | Ni: 0.1 μm | Cu: 0.2 μm | Ag: 2 μm | 39 | ◯ |
| | 24 | 8 | Ni: 0.1 μm | NONE | Ag: 2 μm | 39 | ◯ |
| | 25 | 8 | Fe: 0.2 μm | Cu: 0.2 μm | Ag: 2 μm | 39 | ◯ |
| | 26 | 12 | NONE | NONE | Ag: 2 μm | 34 | ◯ |
| | 27 | 12 | Cu: 0.2 μm | NONE | Ag: 2 μm | 34 | ◯ |
| | 28 | 12 | Ni: 0.1 μm | Cu: 0.2 μm | Ag: 2 μm | 34 | ◯ |
| | 29 | 12 | Ni: 0.1 μm | NONE | Ag: 2 μm | 34 | ◯ |
| | 30 | 12 | Fe: 0.2 μm | Cu: 0.2 μm | Ag: 2 μm | 34 | ◯ |
| | 31 | 14 | NONE | NONE | Ag: 2 μm | 34 | ◯ |
| | 32 | 14 | Cu: 0.2 μm | NONE | Ag: 2 μm | 34 | ◯ |
| | 33 | 14 | Ni: 0.1 μm | Cu: 0.2 μm | Ag: 2 μm | 34 | ◯ |
| | 34 | 14 | Ni: 0.1 μm | NONE | Ag: 2 μm | 34 | ◯ |
| | 35 | 14 | Fe: 0.2 μm | Cu: 0.2 μm | Ag: 2 μm | 34 | ◯ |

According to the samples (Nos. 21 to 35) regarding Example 4 as the present example, it becomes able to obtain the electrical conductivity thereof to become good sufficiently, by performing the plating to form the plated layer thereon. Moreover, it becomes able to obtain the operability of switching regarding the switch using therewith to be as sufficiently good thereby.

### INDUSTRIAL APPLICABILITY

The copper-based deposited alloy strip for contact materials according to the present invention is well preferably applicable to the copper-based deposited alloy strip for contact materials, by which it becomes able to improve an operability of switching regarding a multifunction (multiple contact) switch to be used for such as an electronic device or the like. Moreover, the process for producing an alloy strip according to the present invention is well preferably applicable to a process for producing the above mentioned copper-based deposited alloy strip for contact materials.

Thus, the present invention is described with the embodiments, however, the present invention will not be limited to every detail of the description as far as a particular designation, and it should be interpreted widely without departing from the spirit and scope of the present invention as disclosed in the attached claims.

The present invention claims the priority based on Japanese Patent Application No. 2006-248468 patent applied in Japan on the thirteenth of September, 2006, and on Japanese Patent Application No. 2007-237213 patent applied in Japan on the twelfth of September, 2007, the entire contents of which are expressly incorporated herein by reference.

1. A copper-based deposited alloy strip for a contact material having a maximum value of a difference not larger than 100 MPa among a tensile strength in a rolling direction thereof, a tensile strength in a direction crossing the rolling direction with an angle of 45 degrees, and a tensile strength in a direction crossing the rolling direction with an angle of 90 degrees.

2. The copper-based deposited alloy strip for a contact material according to claim 1, further having an electrical conductivity of not less than 30% IACS.

3. The copper-based deposited alloy strip for a contact material according to claim 1, further having a top surface layer plated with a noble metal or an alloy thereof selected from the group consisting of Ag, Au, Pd, Ru, and Rh.

4. The copper-based deposited alloy strip for a contact material according to claim 3, further having an under-plating layer formed of at least one of Cu, Ni, Fe, and Co or an alloy thereof.

5. The copper-based deposited alloy strip for a contact material according to claim 4, wherein said under-plating layer is comprised of at least two layers.

6. The copper-based deposited alloy strip for a contact material according to claim 1, containing Ni as between 2 and 4 mass %, Si as between 0.4 and 1 mass %, and a remaining component comprised of an unavoidable impurity and Cu.

7. The copper-based deposited alloy strip for a contact material according to claim 6, further containing at least one selected from the group consisting of Mg as between 0.05 and 0.2 mass %, Sn as between 0.1 and 0.5 mass %, Zn as between 0.1 and 1 mass %, and Cr as between 0.05 and 0.5 mass %.

8. A process for producing the copper-based deposited alloy strip for a contact material according to claim 1, comprising the steps of:
performing a solution heated treatment on a copper alloy strip; and
performing an aging heat treatment on the copper alloy strip.

9. The process for producing the copper-based deposited alloy strip for a contact material according to claim 8, further comprising the step of performing a cold rolling on the copper alloy strip at a rolling rate not higher than 30%, after performing the aging heat treatment.

10. The process for producing the copper-based deposited alloy strip for a contact material according to claim 8, further comprising the step of performing an annealing on the copper alloy strip for relaxing a distortion thereof, after performing the aging heat treatment or the cold rolling at the rolling rate not higher than 30%.
